(19) United States
(12) Patent Application Publication
(10) Pub. No.: US 2017/0165886 A1
(43) Pub. Date: Jun. 15, 2017

(54) SHEET MATERIAL HAVING BI-DIRECTIONALLY FORMED MICROPORES AND MANUFACTURE METHOD THEREOF

(71) Applicant: GIXIA GROUP Co., Jhubei City (TW)

(72) Inventors: Jung-Ya HSIEH, Jhubei City (TW); Yung-fu LIN, Jhubei City (TW); Yuan-Hsin CHANG, Jhubei City (TW)

(73) Assignee: Gixia Group Co.

(21) Appl. No.: 15/039,320

(22) PCT Filed: Oct. 13, 2014
(86) PCT No.: PCT/CN2014/088507

§ 371 Date: May 25, 2016

(30) Foreign Application Priority Data
Dec. 6, 2013 (CN) 201310659072.2

(51) Int. Cl. B29C 45/37; B29C 59/04; B29C 45/40

(52) U.S. Cl. CPC B29C 45/37; B29C 45/40; B29C 59/04; B29L 2007/002

(57) ABSTRACT

The present invention provides a sheet material having bi-directionally formed micropores, pertaining to the field of material structures. The sheet material comprises a basic half side and a protrusive half side extending from the basic half side. The basic half side is formed with multiple recesses extending along a first orientation; while the protrusive half side has multiple beams extending along a second orientation. Herein the second orientation extends at an angle with respect to the first orientation, and a bottom edge is respectively formed at the intersection of the beam and the neighboring beam; also, a hole is respectively formed at the crossing position of the bottom edge and the recess.

### FIELD OF THE INVENTION

The present invention generally relates to a sheet material having bi-directionally formed micropores and a manufacture method thereof; in particular, it relates to a sheet material suitable for acoustic absorption or permeable waterproof applications.

### BACKGROUND OF THE INVENTION

Regarding to the living environments in modern cities, it is rather common that buildings are closely constructed, but open, tranquil areas such as parks, green sites or campuses are rare. In such metropolitans, space is very precious and people's habitation environment may be heavily compressed, no sufficient room for buffering from the next door, thus ambient noise could occur and interfere with people anytime. Especially, for domiciles located along or close to the two sides of street, super highways or railroads, the noise from automobiles or trains may seriously deteriorate the living quality. Also, the walls of most of apartments usually may not provide good acoustic isolation effects, sounds or voices from a hi-fi stereo, TV set or children's shouting in the neighbors may become vexing noises for the people living nearby, thus causing negative influences on tranquility in personal space. Therefore, relevant industries have continuously devoted efforts in the research and development for the purpose of improved acoustically absorptive structures, but, currently, the machining and tooling for the majority of such acoustically absorptive structures remain to be quite complicated, and one extra acoustically absorptive film may be required to placed within the acoustic absorption boards in some cases thus leading to higher manufacture costs.

With respect to this issue, some proposed a type of integrally formed acoustically absorptive structure, as shown in FIGS. 1 and 2, wherein a metallic sheet material is machined such that one side thereof provides a delicate multiple-curved-planed surface 11, while the other side provides delicate geometric hole grooves 12. It can be seen that the tapered surface of the delicate geometric hole groove 12 allows acoustic waves to bound back and forth and guides such sound waves into the delicate geometric hole groove 12. Then, a point is configured at the groove bottom of the delicate geometric hole groove 12, which needs to be precisely positioned in alignment to the point at the center of the four squires in the delicate multiple-curved-planed surface 11 such that these two points are mutually matched to form a through-hole. In this way, the acoustic wave can be successfully captured by the stereo surface of the delicate geometric hole groove 12 and guided to pass this through-hole.

However, it can be appreciated from its structure that the manufacture operations in this solution may be quite challenging. In case of using punching processes for one-time machining formation, in fabrication, the front and rear moulds have to be precisely aligned and matched and deviations there between may be intolerable, otherwise the concave point at the groove bottom in the delicate geometric hole groove 12 may miss the concave point at the valley bottom in the delicate multiple-curved-planed surface 11. But such a missing between two concave points caused by machining errors may result in penetration failure and be extremely hard for amendment. That is, on one hand, the yield may remain pretty low thus wasting resources like materials and time, and, on the other hand, it may undesirably require further re-machining operations.

Particularly, if the hole has a depth to a certain extent, in order to perform the punch process for one-time machining, at least one side of such a two-sided mould need to have a sharp and solid structure so as to penetrate the metallic board thereby forming the through-holes. Also, in the metal machining process, the abrasions may be significantly higher than general moulds, thus greatly elevating the tooling costs. Besides, to prevent cracks or bending issues in the mould during the through-hole punch processing, the material selected for the mould must fulfill some requirements and the piercing part should not be too narrow but remain a certain width, thereby reducing the possibility of breaking up and maintaining the usability of the mould. But, in opposite, the requirements on such a structure may reversely constrain the hole diameter of the acoustic holes, limited to a certain specific threshold size and unable to create smaller micropores.

Finally, it is also necessary to take the simultaneous one-time machining or separate machining on both front and rear sides into consideration. By using the simultaneous one-time machining, the mould in charge of hole piercing needs to penetrate the machined metallic board and has to be precisely aligned to make sure that the through-hole can exactly go through the metallic board to the other side. Herein the mould of the protrusions could possibly hit the mould of the other side thus causing damages thereto; on the contrary, to prevent such an impact risk between moulds, there could exist certain possibilities of no penetration in the through-hole, hence inevitably confronting with a dilemma in operations.

Whereas, if alternatively applying the separate machining process, the throughput performance may be lowered, more time is needed in the tooling stage, and the annoying and difficult matching issue remains nonetheless. Since the hole diameters in this type of acoustic absorption holes usually are small, commonly just tens of micrometers to hundreds of micrometers, the difficulty in the precise matching for the moulds on both sides in two separate tooling processes of two independent work sequences may be even higher, and the likelihood of through-hole position deviations can greatly arise, thus resulting in greatly lessened product yields.

### SUMMARY OF THE INVENTION

Therefore, the present invention attempts to provide a sheet material having bi-directionally formed micropores and manufacture method thereof, which not only significantly simplifies the conventional mould and enables the fabrication of more delicate and finer acoustically absorptive holes, but also supports one-time formation and separate formation at the same time, thus greatly reducing the risk of mould collisions and thoroughly resolving the issue of coordination matching in machining while improving the product yield and throughput efficiency.

An objective of the present invention is to provide a method for manufacturing a sheet material having bi-directionally formed micropores thereby reducing the manufacture costs by means of mould structure simplifications.

Another objective of the present invention is to provide a method for manufacturing a sheet material having bi-directionally formed micropores thereby creating more delicate and finer holes to enhance the acoustic isolation effect.

Yet another objective of the present invention is to provide a method for manufacturing a sheet material having bi-directionally formed micropores thereby significantly reducing the complexity in the matching operation and effectively improving the product yield and throughput efficiency.

Still another objective of the present invention is to provide a method for manufacturing a sheet material having bi-directionally formed micropores thereby enabling to select the one-time machining or the two-sided individual machining process so as to increase the flexibility in manufacture operations.

Yet still another objective of the present invention is to provide a sheet material having bi-directionally formed micropores such that the bi-directional mould allows the formation of through-holes by means of line-to-line angled crossing for positioning thus replacing the point-to-point matching in order to manufacture more delicate and finer holes.

Also still another objective of the present invention is to provide a sheet material having bi-directionally formed micropores allowable for achieving the air-permeation and waterproof effects by means of hydrophobic processes.

To achieve the aforementioned objectives, the present invention provides a method for manufacturing a sheet material having bi-directionally formed micropores, comprising the following steps: a) providing a sheet material; and b) machining the two sides of the sheet material thereby respectively forming a protrusive half side and a basic half side, wherein the basic half side is formed with multiple recesses extending along a first orientation; and the protrusive half side extends from the basic half side and has multiple beams extending along a second orientation, the second orientation extends along a direction at an angle with respect to the first orientation, and the intersection of the beam and the neighboring beam respectively has a bottom edge such that a hole is respectively formed at the crossing position of the bottom edge and the recess.

Moreover, a sheet material having bi-directionally formed micropores can be manufactured by means of the above-said method, comprising: a basic half side, formed with multiple recesses extending along a first orientation; a protrusive half side, extending from the basic half side and having multiple beams extending along a second orientation, in which the second orientation extends in a direction at an angle with respect to the first orientation, and the intersection of a beam and a neighboring beam respectively has a bottom edge such that a hole is respectively formed at the crossing position of the bottom edge and the recess.

Accordingly, the present invention discloses a sheet material having bi-directionally formed micropores and manufacture method thereof, which can fabricate the protrusive half side and the basic half side by means of a simple mould crossing structure so that the crossing position of the bottom edge and the recess can naturally constitute delicate and fine holes thereby not only simplifying the mould structure, increasing the selection flexibility in manufacture workflows, reducing manufacture costs, but also capable of improving the manufacture yield and throughput efficiency, further allowing to make smaller holes in order to provide enhanced acoustic isolation performance thus integrally completing all of the previously described objectives.

### BRIEF DESCRIPTION OF THE DRAWINGS

FIG. 1 shows a stereo view of prior art, illustrating the formation of through-holes by matching the delicate geometric hole grooves with the delicate multiple-curved-planed surface;

FIG. 2 shows a stereo view of prior art, illustrating the formation of through-holes by matching the delicate geometric hole grooves with the delicate multiple-curved-planed surface;

FIG. 3 shows a stereo view for a first preferred embodiment of the present invention, illustrating the formation of through-holes by means of line-to-line intersections;

FIG. 4 shows a side view for the first preferred embodiment of the present invention, presenting the extended valley having a cross-section of triangular shape in the recess;

FIG. 5 shows a side view for the first preferred embodiment of the present invention, presenting the cross-section of triangular column shape in the beam;

FIG. 6 shows a flowchart for the first preferred embodiment of the present invention, illustrating the steps for the formation of sheet material by means of one-time machining;

FIG. 7 shows a flowchart for a second preferred embodiment of the present invention, illustrating the steps for the formation of sheet material by means of separate machining as well as hydrophobic processing;

FIG. 8 shows a flowchart for a third preferred embodiment of the present invention, illustrating the manufacture steps for injecting formation of the bi-directionally formed micropores according to the present invention;

FIG. 9 shows a top view for the third preferred embodiment of the present invention, illustrating the curved shape exhibited by the bottom edge and the beam; and

FIG. 10 shows a side view for the third preferred embodiment of the present invention, illustrating the expanding dome shape exhibited by the structure of the mould set and the beam.

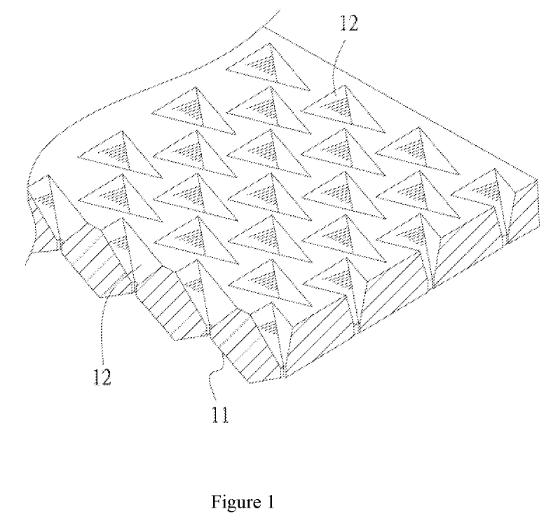

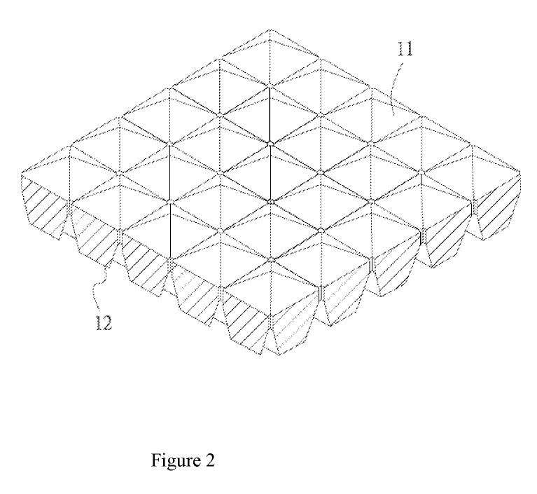

### DETAILED DESCRIPTION OF THE ILLUSTRATED EMBODIMENTS

The aforementioned texts and other technical contents, aspects and effects in relation with the present invention can be clearly presented through the detailed descriptions concerning the preferred embodiments of the present invention in conjunction with the appended drawings; moreover, in each embodiment, the same components will be denoted with similar numbers.

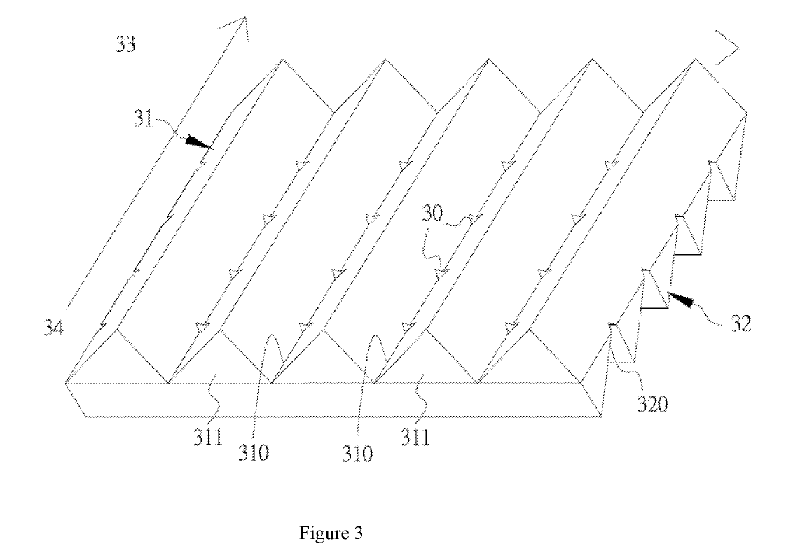

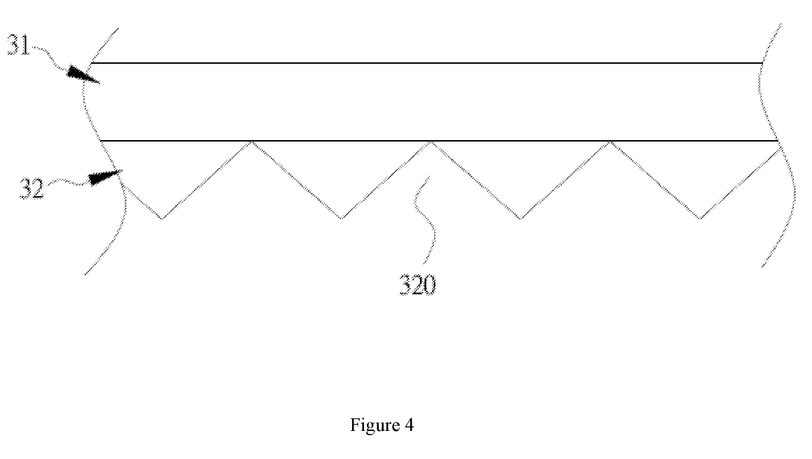

A sheet material having bi-directionally formed micropores according to a first preferred embodiment of the present invention is shown in FIGS. 3 and 4, wherein the two sides of the sheet material are respectively formed with a basic half side 32 and a protrusive half side 31 by means of a rolling process, and in the present embodiment, the outer edges of the rollers on the upper and lower sides are respectively formed with parallel protrusive pressure bars, and the protrusive pressure bars on the upper roller and the lower roller are arranged in a mutually vertical fashion. Therefore, after the roller pressing, multiple recesses 320 are formed on the basic half side 32 which are created by pressing down from the flat plane of the basic half side, and the cross-section thereof exhibits an extended valley of triangular shape. The recesses 320 extend along a first orientation, and, in the present embodiment, the first orientation is exemplified as the X direction 33, so each of the recesses 320 looks like a line and is mutually parallel. Also, the protrusive half side 31 is formed on the side opposite to the basic half side 32, and it can be seen from the Figures that the protrusive half side 31 is integrally formed with the basic half side 32 by using the same sheet material, as if extending from the basic half side 32.

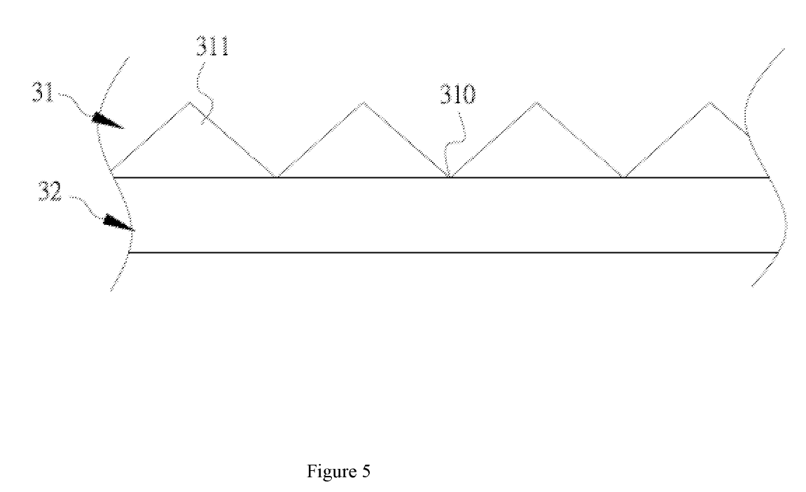

Next, refer conjunctively to FIG. 5, wherein the protrusive half side 31 is formed with multiple protrusions, and to facilitate brief illustrations, they are defined as the beams 311 in the present embodiment, with each of the beams 311 extending along a second orientation in a bar-shaped distribution mutually parallel to the Y direction 34. It can be observed from a lateral angle that the cross-section of the beam 311 in the present embodiment exhibits a triangular shape, like a mountain ridge; meanwhile, from a top angle of FIG. 3, it can be seen as a series of hills extending in a mutually parallel fashion. Since the roller structure in the rolling punching process may be less complicated, the manufacture costs for the mould can be greatly reduced, along with effectively improved throughput efficiency because of lowered matching precision requirement.

In addition, it can be appreciated from FIGS. 3 and 5 that, since the beam 311 is protrusive, a lowest position can formed between a beam 311 and an adjacent beam 311, which is located at the border thereof as a valley bottom between two mountains. Besides, the beam 311 has a straight-lined profile, so the border between two neighboring beams 311 is also linear and extends along the Y direction 34 in FIG. 3. Considering the perspective and convenience for illustration, such a lowest position is herein defined as a bottom edge 310.

Seeing that the basic half side 32 and the protrusive half side 31 are respectively constituted on the two mutually opposite sides, the concavity from the surface of the basic half side 32 will gradually get closer to the protrusive half side 31 located on the other side; i.e., the lowest position on the protrusive half side 31 is closer to the basic half side 32 on the other side. Accordingly, suppose the X direction 33 and the Y direction 34 form an angle in intersection with respect to each other, then the bottom edge 310 and the recess 320 also intersect from a top view. In machining, it needs merely to drill the bottom edge 310 having a triangular cross-section and the recess 320 to a sufficient depth, slightly penetrating the protrusive half side 31 and the basic half side 32, then the intersection of any two lines may go through thus forming a through-hole 30 penetrating the entire sheet material.

Moreover, because the basic half side 32 and the protrusive half side 31 in the present invention are both linear, the moulds for the two sides in machining can form the through-hole 30 simply by means of making the extensions of such lines cross over each other; in this way, the matching formation of these through-holes 30 may become pretty convenient. In comparison with prior art, the method according to the present invention may largely decrease the difficulty in fabricating the through-hole 30, thus improving the product yield to a significant extent.

Especially, in the aforementioned prior art, the moulds for through-hole formation may not be overly slim thus limiting the hole diameter of the through-hole, but, through the present invention, even the slopes of the protrusive pressure bars in the upper and lower rollers may be relatively steep, the damage issue can be effectively reduced or eliminated because of their parallel mountain-ridged distributions; in other word, the prior art mould needs to have a tapered tip, but a steep columnar structure is applied in the present invention, indicating the fabrication of acoustic absorption holes of small hole diameters can be more practical and convenient.

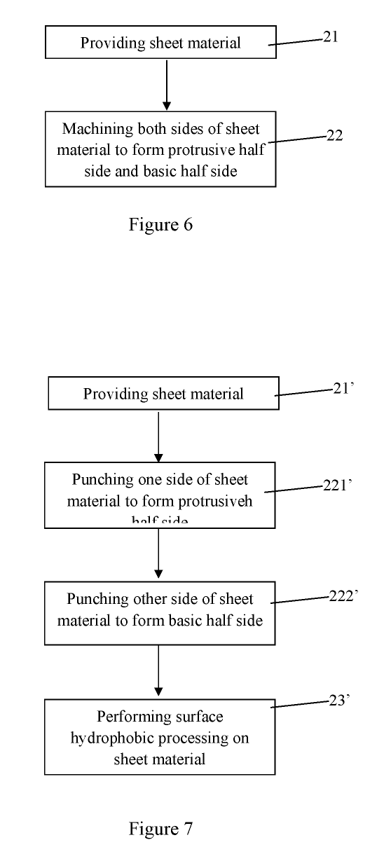

FIG. 6 shows a machining fabrication method according to the present invention, herein using the roller pressing approach as an example. Initially, in Step 21, a sheet material is provided for the machining process. In Step 22, the sheet material is roller pressed so as to form the structures on both sides of the sheet material in a bi-directional machining way; that is, one side thereof is roller pressed to constitute the aforementioned protrusive half side, while the opposite side is synchronously roller pressed to form the above-said basic half side. The structure on the protrusive half side extends along a second orientation for formation, and the structure on the basic half side otherwise extends along a first orientation for formation. Herein the second orientation extends in a direction at an angle with respect to the first orientation such that multiple bottom edges and multiple recesses can mutually intersect. Therefore, after completing the roller pressure process, plural penetrating through-holes can be naturally created on the sheet material.

Based on actual tests, in case the hole diameter at the narrowest part of such holes is not greater than 0.2 mm, the acoustic absorption effect may be accordingly further improved. It should be noted that the cross-sections of the aforementioned beams and recesses may be suitably adjusted in accordance with various demands, which are by no means limited to simple triangular columns or extended valleys as previously described. That is, the above-said triangular shape may be altered to have concave or convex waist parts at its two sides and still fall within the scope of the present invention.

Hence, through the aforementioned manufacture method, the sheet material having bi-directionally formed micropores according to the present invention can not only resolved the issues found in prior art so as to reduce the hole diameter at the narrowest part of the acoustic absorption holes to less than 0.2 mm, but also allow to create finer and smaller through-holes based on actual requirements thereby enhancing the sound isolation effect and ensuring the living quality. Or further, it is possible to follow the previously described contents to continuously reduce the hole diameter of the sheet material having bi-directionally formed micropores to 0.1 μm at which even water drops can not go through it.

Next, a second preferred embodiment according to the present invention is provided, wherein the application of the previously illustrated structure is shifted from the scope of sound isolation to the fields of waterproof and air permeation. For example, to design an air permeable raincoat or a waterproof jacket, umbrella or the like, it needs to prevent the permeation of water drops and, at the same time, allows the inward and outward airflows so as to avoid undesirable sultriness. Under such a circumstance, the manufacture method according to the present invention may utilize the separate machining manufacture operations. As shown by FIG. 7 illustrating the manufacture sequence in the second preferred embodiment of the present invention, in Step 21′, a sheet material is provided; then, in Step 221′, one side of the sheet material is first firmly abutted thereby applying the punching fabrication process onto the other side. After the first punching, then in Step 222′, turn over the sheet material and abut it firmly to apply the punching process onto the un-machined side in order to sequentially form the protrusive half side and the basic half side. It should be noted that the formations of the protrusive half side and the basic half side need not to follow a specific order, but can be customized based on actual demands.

Herein the first orientation and second orientation in the present embodiment are mutually orthogonal, so the beams and the recesses are vertical with respect to each other thus exhibiting an interleaving web structure. Also, the hole diameter at the narrowest part of the through-holes in the sheet material formed with Steps 221′ and 222′ is not be greater than 0.1 μm, which is prescribed to block water drops from penetrating. Besides, in Step 23′, the surface of the sheet material is hydrophobia processed. Through the process in this Step, the material of the sheet material and water drops may become incompliant. Therefore, even a user may leave it unmoved in a long-term period so water drops reside thereon all the time, water drops can not permeate into the holes, thus improving the waterproof effect. On the contrary, thank to the above-said micropores, air can easily go through the sheet material such that the structure according to the present invention can let sweat from a human body be brought away by air but exterior rainfall may not penetrate thereby achieving the required waterproof and perspiration emission features.

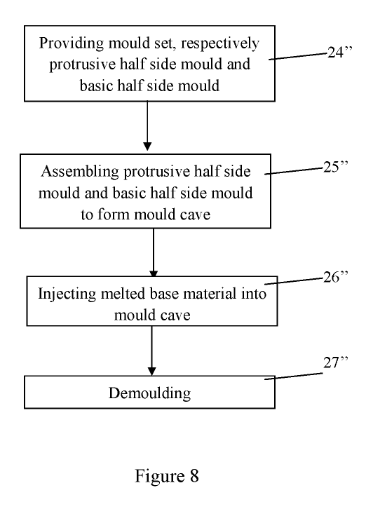

Certainly, those skilled ones in the art can conveniently appreciate that the above-said roller pressing operations are by no means limitations to the scope of the present invention, but other fashions like injection formation with plastic materials or other mixtures doped with various substances can also achieve the same effects; in particular, based on the profile of the mould, the first orientation and the second orientation illustrated in the present embodiment may be more complicated than just the X direction and the Y direction in practice. Therefore, refer conjunctively to FIGS. 8, 9 and 10, wherein a third preferred embodiment according to the present invention applies an injection formation approach to form the above-said second orientation 34″ to a curve, rather than a straight line.

Initially, in Step 24″, a mould set is provided and consists of a protrusive half side mould 41″ and a basic half side mould 42″. Herein the basic half side mould 42″ is formed with multiple protrusions 420″ extending along a first orientation 33″, while the protrusive half side mould 41″ has multiple valleys 411″ extending along an exemplarily curved second orientation 34″. Following this, in Step 25″, the protrusive half side mould 41″ and the basic half side mould 42″ are adjoined to constitute a mould cave. The combined mould set allows each valley 411″ and the adjacent valley 411″ to mutually intersect to form a top edge 410″. By assembling the protrusive half side mould 41″ and the basic half side mould 42″ into the mould set, the top edge 410″ of the protrusive half side mould 41″ can be in cross contact with the protrusions 420″ of the basic half side mould 42″ such that each of cross contact positions can form a contact point. Then, in Step 26″, the melted base material of plastic material can be injected into the mould cave so as to form the intended sheet material having bi-directionally formed micropores. And, in the last Step 27″, let the plastic cool off and then perform the demoulding process. Besides, it is possible to perform the surface hydrophobic processing based on actual requirements.

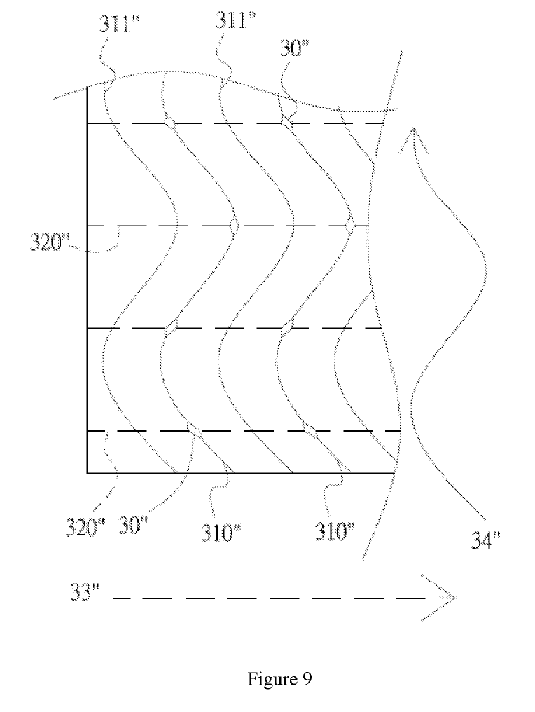

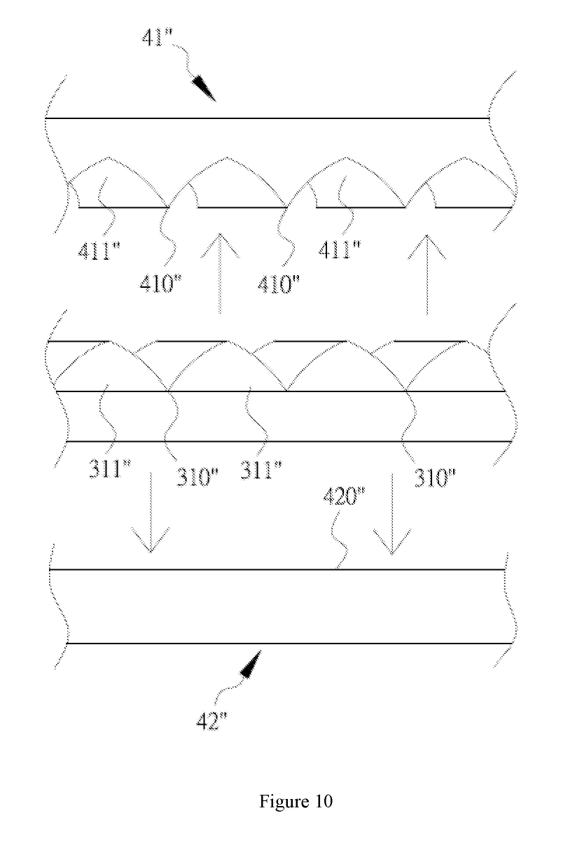

In the sheet material having bi-directionally formed micropores according to the present embodiment, the beams 311″ are manufactured correspondingly to the aforementioned curved valleys 411″, thus of meanderingly curved lines as well. The bottom edges 310″ concave between the two beams 311″ are maintained at an equal distance from the beams 311″ so that the bottom edges 310″ and the beams 311″ exhibit a mutual parallel perspective, as can be seen from the top view in FIG. 9. Meanwhile, the recesses 320″ formed on the other side of the sheet material are linear in the present embodiment; of course, this is by no means restrictive, but can be of other curved lines. Therefore, the cross points of the recesses 320″ and the bottom edges 310″ together create the holes 30″ of the present invention. Herein, referring specifically to the side view in FIG. 10, the shape of the beams 311″ in the present example is not triangular, but of a dome having a slightly expanded curvature.

In summary, the manufacture method according to the present invention is applicable for various machining operations of one-time formation and separate formation or the like. By setting an angle between the first orientation and the second orientation, the linear bottom edges and the linear recesses can mutually intersect. Compared with the required point-to-point matching in the hole formation processes of prior art, the present invention needs only to perform line-to-line intersections to achieve the objective thus offering concise and handy fabrication procedures, and also improving the piercing rate for such through-holes; in addition, it needs merely several beams installed on the both sides of the mould to mutually cross over such that damages to the mould can greatly reduced; furthermore, finer and more delicate micropores can be created so as to enhance the acoustic absorption and waterproof effects. However, it should be appreciated that the descriptions set forth as above all illustrate simply the preferred embodiments of the present invention, rather than restricting the implementation scope of the present invention thereto, and all effectively equivalent changes or modifications conveniently made in accordance with the contents illustrated in the claims and specifications of the present invention should be deemed as falling within the scope of the present invention.

What is claimed is:

1. A sheet material having bi-directionally formed micropores, comprising:
a basic half side, formed with multiple recesses extending along a first orientation;
a protrusive half side, extending from the basic half side and having multiple beams extending along a second orientation, in which the second orientation extends in a direction at an angle with respect to the first orientation, and the intersection of a beam and a neighboring beam respectively has a bottom edge such that a hole is respectively formed at the crossing position of the bottom edge and the recess; characterized in that the hole diameter at the narrowest part of the hole is not greater than 0.2 mm.

2. The sheet material having bi-directionally formed micropores according to the claim 1, characterized in that the hole diameter at the narrowest part of the hole is not greater than 0.1 μm.

3. The sheet material having bi-directionally formed micropores according to the claim 1, characterized in that the first orientation and the second orientation are mutually orthogonal.

4. The sheet material having bi-directionally formed micropores according to the claim 1, characterized in that the beams are columns respectively having a triangular cross-section.

5. The sheet material having bi-directionally formed micropores according to the claim 1, characterized in that at least one of the first orientation and the second orientation is curved.

6. A method for manufacturing a sheet material having bi-directionally formed micropores, comprising the following steps:
c) providing a mould set, which is separated into a protrusive half side mould and a basic half side mould; in which the basic half side mould is formed with multiple protrusions extending along a first orientation, and the protrusive half side mould has multiple valleys extending along a second orientation;
d) assembling the protrusive half side mould and the basic half side mould to constitute a mould cave such that the intersection of the valley and the neighboring valley is respectively formed with a top edge; and the crossing position of the top edge and the protrusion is respectively formed with a contact intersection point;
e) injecting a melted base material into the mould case in order to form the sheet material having bi-directionally formed micropores; and
f) demoulding.

7. The method for manufacturing a sheet material having bi-directionally formed micropores according to the claim 6, characterized in that the base material is a plastic material.

8. The method for manufacturing a sheet material having bi-directionally formed micropores according to the claim 6, characterized in that it comprises a Step g) for surface hydrophobic processing.
